(19) United States
(12) Patent Application Publication
(10) Pub. No.: US 2008/0318111 A1
(43) Pub. Date: Dec. 25, 2008

(54) FUEL CELL

(75) Inventors: Cheng Wang, Hsinchu (TW); Ching-Po Lee, Hsinchu (TW); Jin-Shu Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/868,535

(22) Filed: Oct. 8, 2007

(30) Foreign Application Priority Data
Jun. 21, 2007 (TW) 96122299

(51) Int. Cl. H01M 2/00; H01M 8/00

(52) U.S. Cl. 429/34

(57) ABSTRACT

A fuel cell including a plurality of first fuel cell modules is provided. Each of the fuel cell modules includes a cathode current collector, an anode current collector, a membrane electrode assembly (MEA) and a flow channel cover plate. The anode current collector is disposed above the cathode current collector. The MEA is disposed between the anode current collector and the cathode current collector. The flow channel cover plate is disposed on the anode current collector, for collecting a cathode product. A top side of the flow channel cover plate is adapted to transport a cathode reactant, and a bottom side of the flow channel cover plate is adapted to transport an anode reactant. In addition, the first fuel cell modules are stacked in a manner that the anode current collector faces upwards.

### CROSS-REFERENCE TO RELATED APPLICATION

This application claims the priority benefit of Taiwan application serial no. 96122299, filed Jun. 21, 2007. All disclosure of the Taiwan application is incorporated herein by reference.

### BACKGROUND OF THE INVENTION

1. Field of the Invention

The present invention relates to a fuel cell, and more particularly, to a fuel cell that includes a flow channel cover plate with special design for enhancing the performance of the fuel cell.

2. Description of Related Art

FIG. 1 is a schematic view of a structure of a conventional fuel cell. Referring to FIG. 1, the fuel cell 100 includes two fuel cell modules 102 and a partition plate 104 disposed between the fuel cell modules 102. The fuel cell module 102 includes an anode current collector 106, a cathode current collector 108, a membrane electrode assembly (MEA) 110, and an anode flow field plate 112. The anode current collector 106 and the cathode current collector 108 are attached to opposite sides of the MEA 110, respectively. The anode current collector 106 of the fuel cell module 102 is disposed to face toward the partition plate 104, and the anode flow field plate 112 is disposed between the anode current collector 106 and the partition plate 104.

When methanol solution is used as the anode reactant of the fuel cell 100, carbon dioxide (CO₂) is produced at the anode portion, and water (H₂O) is produced at the cathode portion. With regard to the upper fuel cell module 102 of the fuel cell 100, water vapour produced at the cathode portion, when cooled, condenses into liquid water, and may flow to an outside of the cathode current collector 106. As a result, air may be blocked from entering the MEA 110, which affects an output power of the fuel cell 100. In some fuel cells, a fan is used to remove the water produced in the fuel cells. However, this may consume a considerable amount of power, and cannot completely remove the water.

In addition, with regard to the upper fuel cell module 102, the CO₂ produced at the anode portion rises due to buoyancy, and block a portion of the reaction area of the anode. If the CO₂ is not timely removed, it may accumulate in the anode, and then lower the output power of the fuel cell.

On the other hand, in practical use, multiple fuel cells 100 are usually stacked to form a cell group with higher power. As shown in FIG. 2, in the upper fuel cell 100, if the water vapour is continuously accumulated in the cell and condenses into liquid drops, the liquid drops may further drop onto the cathode of the lower fuel cell 100, and then further lower the output power of the lower fuel cell 100.

Currently, fuel cells have been utilized in electronic products to supply power. With continuous advancement of technologies, portable electronic products, for example, notebook computer, are developed with a trend toward being light, low profile, small and convenient to carry. Therefore, the portable electronic products may have a very small space for placing the fuel cell. After the fuel cell module is assembled into the electronic product, the remaining space may be insufficient for further disposing of a cathode flow field plate that can make the gas flow field passing the fuel cell module uniform. As a result, the output power of the fuel cell modules used in the portable electronic products may be affected.

It can be seen from the above description that increasing the output power of the fuel cell group itself and the output power when the fuel cell group is employed in other products is a critical technology in fuel cell field. Therefore, there is a need for an improved fuel cell which can address one or more of the aforementioned problems caused by water accumulation, blocking of the anode by CO₂ and insufficient space when the fuel cell is employed in the electronic products.

### SUMMARY OF THE INVENTION

Accordingly, the present invention is directed to a fuel cell which addresses various problems of conventional fuel cells, achieves removal and recycle of water, and further avoids the problem that the anode is blocked by CO₂.

In one embodiment, a fuel cell includes a plurality of first fuel cell modules. Each of the fuel cell modules includes a first cathode current collector, a first anode current collector, a first membrane electrode assembly (MEA) and a first flow channel cover plate. The first anode current collector is disposed above the first cathode current collector. The first MEA is disposed between the first anode current collector and the first cathode current collector. The first flow channel cover plate is disposed on the first anode current collector, and is adapted to collect a cathode product of the fuel cell. A top side of the first flow channel cover plate is adapted to transport a cathode reactant of the fuel cell, and a bottom side of the first flow channel cover plate is adapted to transport an anode reactant of the fuel cell. The first fuel cell modules are stacked together.

The fuel cell includes the flow channel cover plate specially designed such that the top side of the flow channel cover plate is adapted to transport cathode reactant and the bottom side is adapted to transport anode reactant. Therefore, lowering of the output power of the fuel cell due to accumulation of the water produced at the cathode portion is avoided. In addition, the fuel cells are stacked in a manner that the anode current collector faces upwards, thereby avoiding that the anode reaction area is blocked by CO₂ and increasing the output power of the fuel cell. Furthermore, the fuel cell is configured to have a reduced overall thickness and occupy small space, and therefore, it is more suitable for electronic products that are light, low-profile and small.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a structure of a conventional fuel cell.

FIG. 2 is a schematic view of a structure of a conventional fuel cell stack.

FIG. 3 is a schematic view of a structure of a fuel cell according to a first embodiment of the present invention.

FIG. 4A is a schematic view of a flow channel cover plate according to another embodiment of the present invention.

FIG. 4B is a schematic view of a structure of a fuel cell according to another embodiment of the present invention.

FIG. 4C is schematic view of a flow channel of the flow channel cover plate according to another embodiment of the present invention.

FIG. 5A is a side view showing the fuel cell in an electronic product according to the first embodiment of the present invention.

FIG. 5B is a top view showing the fuel cell in an electronic product according to the first embodiment of the present invention.

FIG. 5C is a comparison view showing the fuel cell and a planar flow channel cover plate of the first embodiment of the present invention.

FIG. 6 is a schematic view of a structure of a fuel cell according to a second embodiment of the present invention.

FIG. 7 is a schematic view of a structure of a fuel cell according to a third embodiment of the present invention.

FIG. 8 is a schematic view of a structure of a fuel cell according to a fourth embodiment of the present invention.

FIGS. 9A to 9D are schematic views of a structure of a fuel cell according to a fifth embodiment of the present invention.

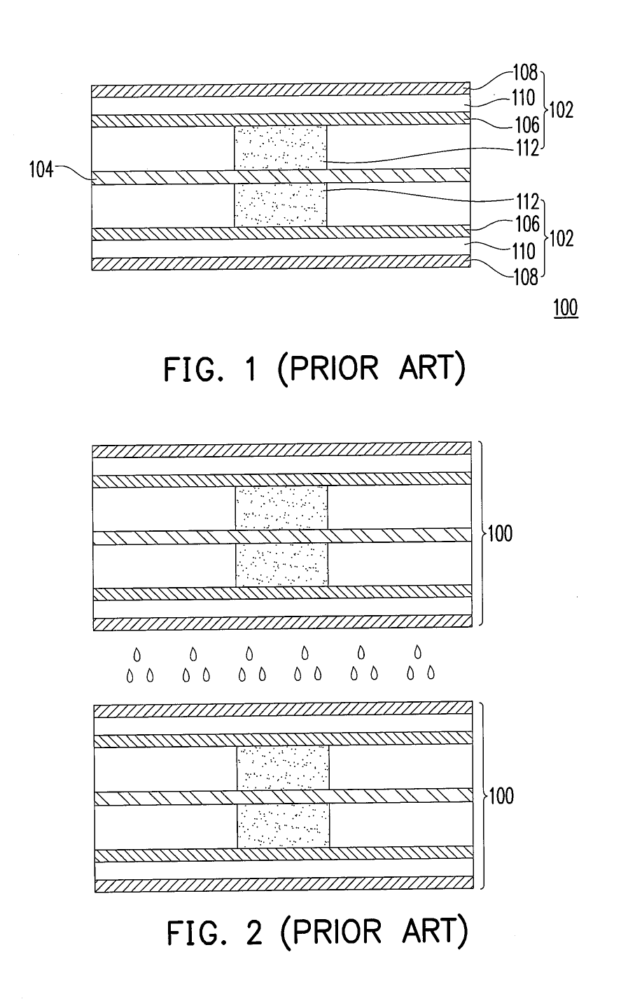

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

Multiple exemplary embodiments are described below to show the fuel cell of the present invention. In addition, in the exemplary embodiments, the fuel cell includes a stack of two fuel cell modules. However, the number of the stacked fuel cell modules is not limited to two, and may be different according to various requirements. Moreover, in these embodiments, methanol solution is taken as an example of the anode reactant of the fuel cell, and air (oxygen) is taken as an example of the cathode reactant.

### First Embodiment

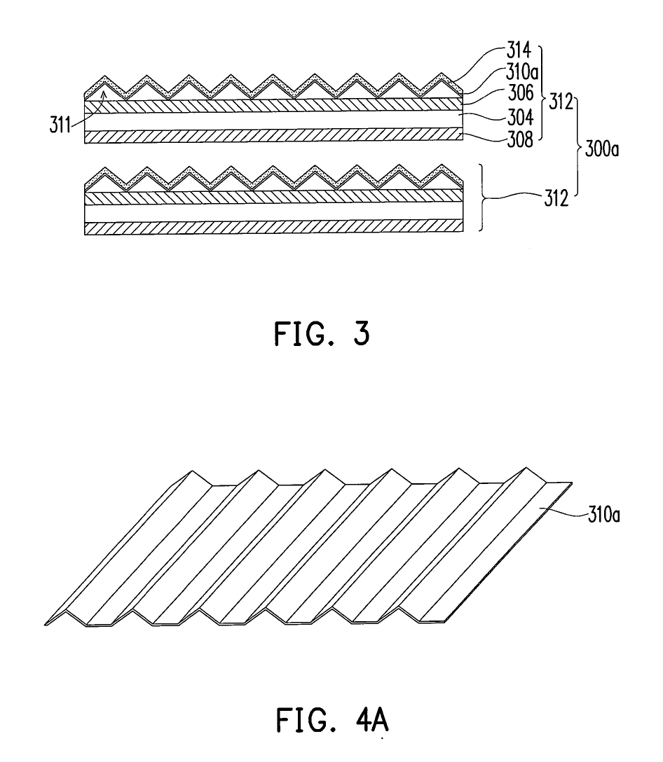

FIG. 3 is a schematic view of a structure of a fuel cell according to a first embodiment of the present invention.

Referring to FIG. 3, the fuel cell 300a includes a plurality of first fuel cell modules 312. In this embodiment, the fuel cell 300 includes two first fuel cell modules 312. Each of the first fuel cell modules 312 includes a membrane electrode assembly (MEA) 304, an anode current collector 306, a cathode current collector 308 and a flow channel cover plate 310a. The anode current collector 306 is disposed above the cathode current collector 308, and the MEA 304 is disposed between the cathode current collector 308 and the anode current collector 306. In the illustrated construction, the anode current collector 306 and the cathode current collector 308 are comprised of, for example, stainless steel or any metal resistant to anode reactant erosion, or porous current collectors (gold plated) that are fabricated by build-up circuit board manufacturing process. In addition, the MEA 304 mainly includes a proton exchange membrane (PEM), an anode catalyst layer and a cathode catalyst layer disposed at two sides of the PEM, an anode gas diffusion layer disposed on the anode catalyst layer, and a cathode gas diffusion layer disposed on the cathode catalyst layer.

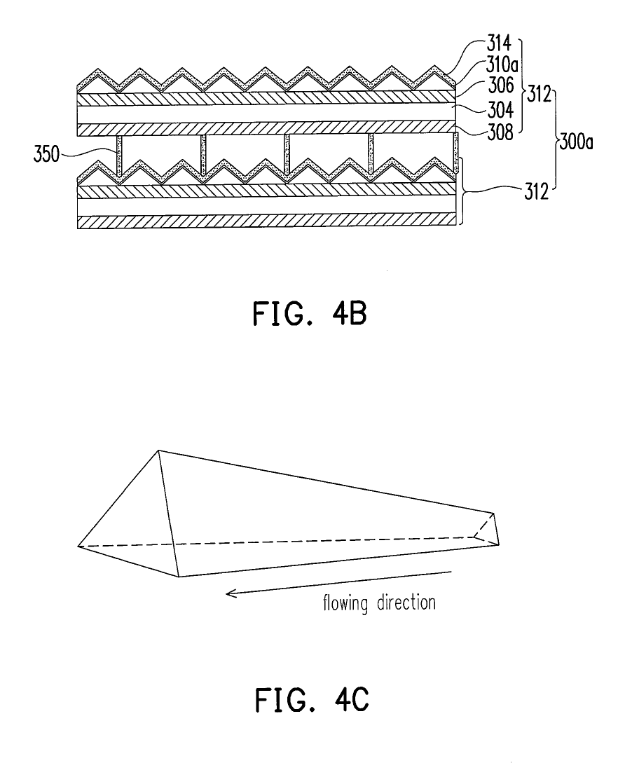

The flow channel cover plate 310a of the first fuel cell module 312 is disposed on the anode current collector 306. The flow channel cover plate 310a is, for example, a serrated thin plate. The material of the flow channel cover plate 310a is, for example, an insulating material resistant to acid and alkali, such as, an organic fiber glass substrate (FR4 or FR5), or an erosion-resistant thin metal plate that is plated with Teflon. Moreover, the flow channel cover plate 310a may further be, for example, a wavy thin plate (shown in FIG. 4A). Furthermore, support structures 350, such as columns or protruding ribs (shown in FIG. 4B), may be disposed on the flow channel cover plate 310a to provide the structural strength when the fuel cell 300a is pressed. Moreover, a top side of the flow channel cover plate 310a is adapted to transport cathode reactant, for example, air (oxygen), and a bottom side of the flow channel cover plate 310a is adapted to transport anode reactant, for example, methanol solution. More particularly, when the air (oxygen) flows to the top side of the flow channel cover plate 310a, the serrated flow channel cover plate 310a makes the air uniformly flow through the surface of the cathode current collector 308, thus eliminating the need of additional flow field plates in existing fuel cells. A space 311 formed between the flow channel cover plate 310a and the anode current collector 306 allows the anode reactant to flow therethrough. Therefore, the flow channel cover plate 310a provides flow paths for both anode reactant and cathode reactant.

In addition, referring to FIG. 3 and FIG. 4C, in this embodiment, the first fuel cell modules 312 of the fuel cell 300a are stacked in a manner that the anode current collector faces upwards (i.e., the direction of gravity is downwards). Therefore, the CO₂ produced at the anode portion of the first fuel cell module 312 floats to the flow channel cover plate 310a due to buoyancy, which is different from the conventional fuel cells in which the anode reaction area is blocked and the output power of the fuel cell is reduced. In the wavy flow channel cover plate 310a of the embodiment of the present invention, the area of the cross section of the wave crest gradually increases along the flowing direction of the anode reaction (shown in FIG. 4C), for further facilitating removal of CO₂. When moving to a bottom of the flow channel, the CO₂ may be discharged via an air permeable waterproofed film. As such, CO₂ does not be accumulated to a next flow channel.

Referring again to FIG. 3, the two first fuel cell modules 312 of the fuel cell 300a are stacked in a manner that the anode current collector 306 faces upwards (i.e., the direction of gravity is downwards). In addition, the first fuel cell modules 312 are interconnected by using an adhesive, a latch mechanism, a hot-pressing technique or a hot-melt technique. After reactions are performed in the first fuel cell modules 312, water vapour is produced at the cathode portion. Water drops condensed from the water vapour drop onto the flow channel cover plate 310a of the lower first fuel cell module 312. With the serration (or wavy) design of the flow channel cover plate 310a, the water at the cathode portion may be effectively removed, and may further be recycled. The flow channels on the flow channel cover plate 310a may be designed to be inclined, and therefore, water accumulated on the flow channels falls down along inclined surfaces on the flow channels. Of course, a water guide layer 314 may be disposed on the flow channel cover plate 310a to further facilitate effective removal and recycle of water produced at the cathode portion. The water guide layer 314 formed on the surface of the flow channel cover plate 310a is, for example, one of a water guide micro-groove structure, a capillary structure material, and hydrophilic or hydrophobic material. The material of the water guide layer 314 is, for example, paper, gauze, cotton cloth, fabric material or other suitable materials.

Hereinafter, the application of the fuel cell of FIG. 3 in an electronic product, particularly a portable electronic product, such as a notebook computer, will be described.

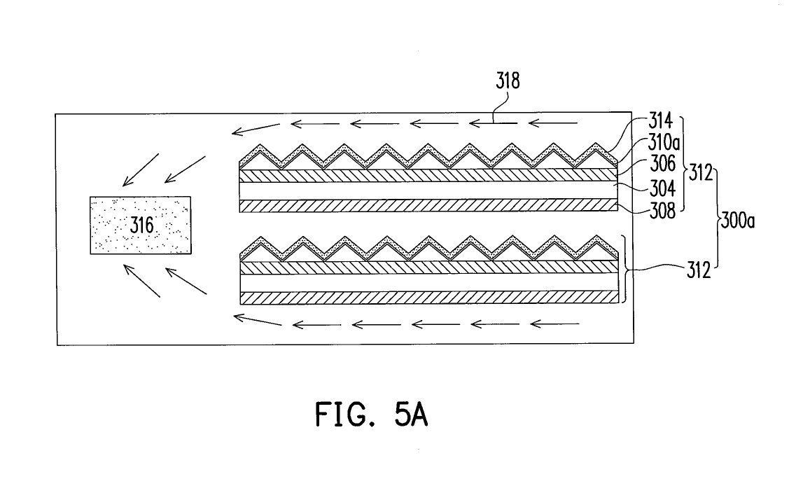

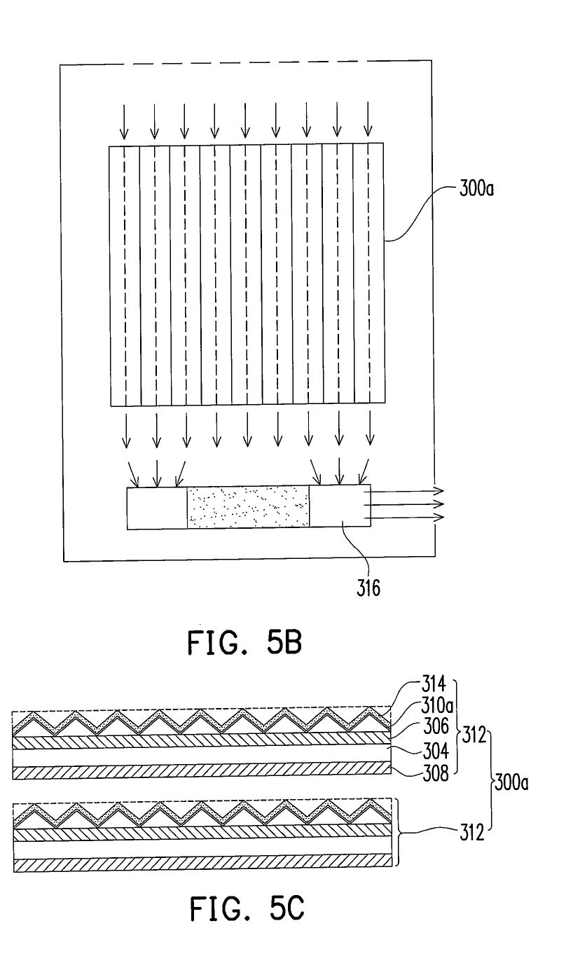

FIGS. 5A through 5C are schematic views showing the application of the fuel cell of the first embodiment of the present invention in the electronic product. In FIG. 5B, the broken lines represent wave troughs of the flow channel cover plate 310a, and the solid lines represent wave crests of the flow channel cover plate 310a. When the fuel cell 300a is disposed in the notebook computer, a fan 316 or another similar cooling element, for example, an air pump, is usually arranged to drive the air to flow through the surface of the cathode current collector 308 (along gas flow direction 318) to provide oxygen and remove the water produced at the cathode portion. Since the flow channel cover plate 310a is designed to be serrated (or wavy), compared with the fuel cell with planar flow channel cover plate (as broken lines in FIG. 5C), the flow channel cover plate 310a provides additional space for airflow between serrations, and, therefore, the flow resistance and hence the fan speed is reduced. As such, the notebook computer operates at a lower noise level and reduces power consumption as well. Besides, because of the serration (wavy) design of the flow channel cover plate 310a, when the fuel cell modules are spaced with a same distance, the fuel cell 300a of this embodiment provides more space for airflow to flow therethrough than the conventional fuel cells, or when having the same flow resistance as the conventional fuel cell, the fuel cell of this embodiment can use more compacted fuel cell module stack with smaller distance to achieve a same output power as that of the conventional fuel cell. In other words, the fuel cell of this embodiment further reduces the overall height of the fuel cell and occupies smaller space, and thus is more suitable for electronic products that are light, low profile, and small.

Of course, when the fuel cell is used in the electronic products, the water is likewise effectively removed, and recycle of the water produced at the cathode portion is facilitated. In addition, the problem that the reaction area of the anode is blocked by CO₂ is avoided. These features and advantages have been described above in detail, and, therefore, are not repeated herein.

### Second Embodiment

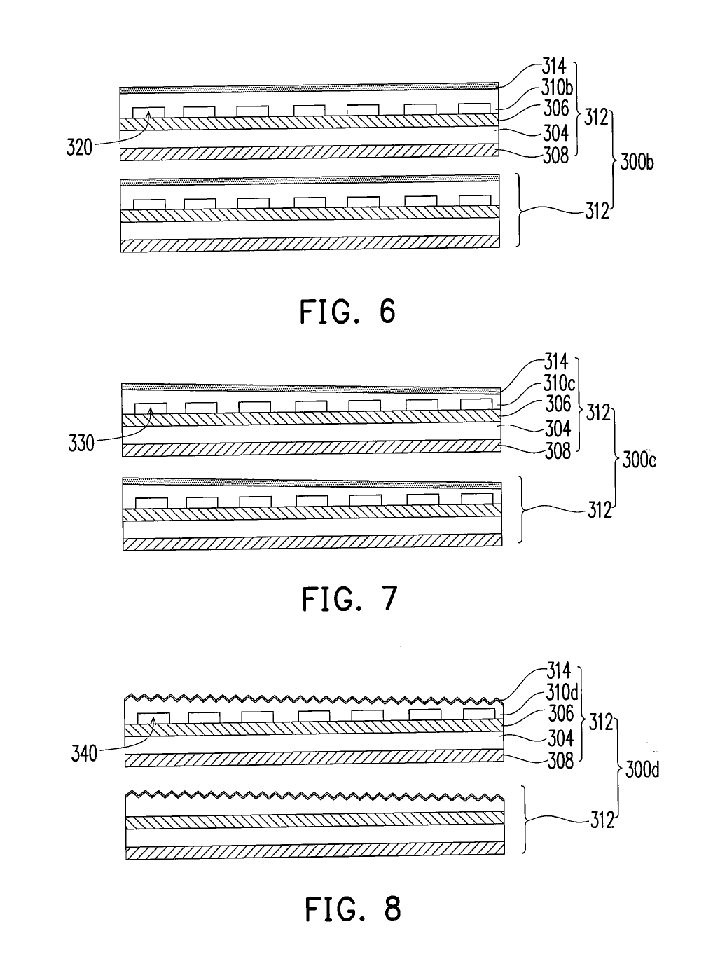

FIG. 6 is a schematic view of a structure of a fuel cell according to a second embodiment of the present invention.

Referring to FIG. 6, the structure of the fuel cell 300b of the second embodiment is substantially similar to that of the fuel cell 300a of the first embodiment, except that the top surface of a flow channel cover plate 310b is a planar surface, and a plurality of flow channels 320 are formed between the bottom surface of the flow channel cover plate 310b and the anode current collector 306 corresponding to the flow channel cover plate 310b. A profile of the flow channels 320 may be rectangular, triangular, circular, or other profiles suitable for facilitating removal of CO₂. Of course, a water guide layer 314 may be disposed on the flow channel cover plate 310b to facilitate effective removal of the water and recycle of the water produced at the cathode portion. Except for the difference described above, the structure, material and function of the fuel cell 300b of the second embodiment are substantially similar to those of the fuel cell 300a of the first embodiment, and are therefore not repeated.

### Third Embodiment

FIG. 7 is a schematic view of a structure of a fuel cell according to a third embodiment of the present invention.

Referring to FIG. 7, the structure of the fuel cell 300c of the third embodiment is substantially similar to that of the fuel cell 300a of the first embodiment, except that a top surface of a flow channel cover plate 310c is an inclined surface, and a plurality of flow channels 330 are formed between a bottom surface of the flow channel cover plate 310b and the anode current collector 306 corresponding to the flow channel cover plate 310b. In the fuel cell 300c, when water drops produced at the cathode portion drop onto a lower fuel cell, the water drops may flow along the inclined surface of the flow channel cover plate 310c, whereby the water can be removed and recycled. Of course, a water guide layer 314 may be disposed on the flow channel cover plate 310c to facilitate effective removal of the water and recycle of the water produced at the cathode portion. Except the difference described above, the structure, material and function of the fuel cell 300c of the third embodiment are substantially similar to those of the fuel cell 300a of the first embodiment, and are therefore not repeated.

### Fourth Embodiment

FIG. 8 is a schematic view of a structure of a fuel cell according to a fourth embodiment of the present invention.

Referring to FIG. 8, the structure of the fuel cell 300d of the fourth embodiment is substantially similar to that of the fuel cell 300a of the first embodiment, except that a top surface of a flow channel cover plate 310d forms a plurality of inclined grooves, a depth of each of the inclined grooves gradually decreases along an extending direction of each of the inclined grooves, and the inclined grooves extend from one side toward another side of the flow channel cover plate 310d corresponding to the inclined grooves. A plurality of flow channels 340 are formed between a bottom surface of the flow channel cover plate 310d and the anode current collector 306 corresponding to the flow channel cover plate 310d. Of course, a water guide layer 314 may be disposed on the flow channel cover plate 310d to facilitate effective removal of the water and recycle of the water produced at the cathode portion. Except the difference described above, the structure, material and function of the fuel cell 300d of the third embodiment are substantially similar to those of the fuel cell 300a of the first embodiment, and are therefore not repeated.

### Fifth Embodiment

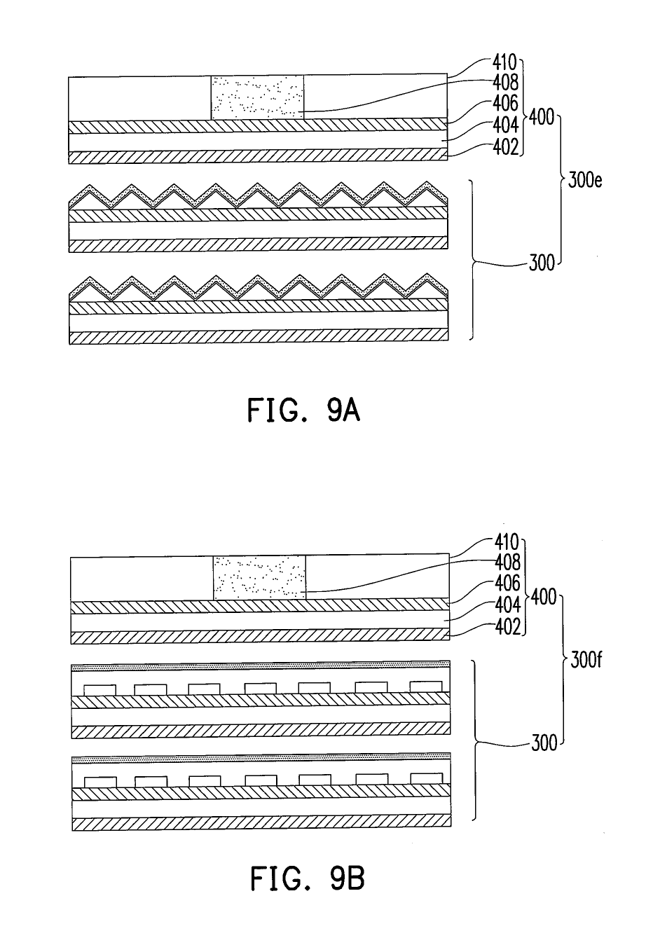

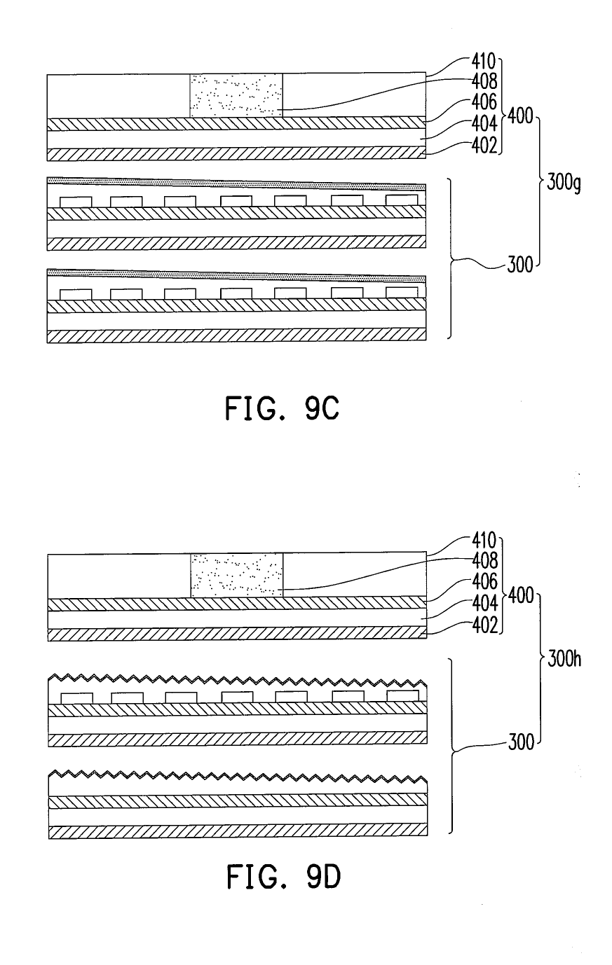

FIGS. 9A through 9D are schematic views of a structure of a fuel cell according to a fifth embodiment of the present invention.

Referring to FIGS. 9A through 9D, the structures of the fuel cell modules 300e, 300f, 300g, 300h are substantially similar to those of the fuel cell 300a of the first embodiment, the fuel cell 300b of the second embodiment, the fuel cell 300c of the third embodiment, the fuel cell 300d of the fourth embodiment, except that each of the fuel cells 300e, 300f, 300g, 300h is formed by arranging a second conventional fuel cell module 400 on a corresponding one of the fuel cells 300a, 300b, 300c, 300d to form a stack. The second conventional fuel cell module 400 includes a second anode current collector 406, a second cathode current collector 402, a second MEA 404, a second anode flow field plate 408, and a housing 410 covering the second anode current collector 406 and the second anode flow field plate 408. In addition, the second fuel cell module 400 is arranged above a plurality of fuel cell modules 312 to form a stack in a manner that the anode current collector faces upwards. The second fuel cell module 400 and the first fuel cell modules 312 are interconnected by using an adhesive, a latch mechanism, hot-pressing and hot-melt technique.

In short, since the output power of the upper most fuel cell will not be affected due to water drops, the fuel cells (300a, 300b, 300c, 300d) of the embodiments of the present invention may be fuel cell (300e, 300f, 300g, 300h) stack structures in which the conventional single second fuel cell module 400 is arranged to be the most upper fuel cell.

However, the embodiments described are not intended to limit the scope of the present invention. For example, the fuel cells 300a, 300b, 300c, 300d of the embodiments of the present invention may be a stack formed by any first fuel cell modules 312 of the first to fourth embodiments.

In summary, the fuel cells (300a, 300b, 300c, 300d, 300e, 300f, 300g, 300h) of the embodiments of the present invention at least has one, a part or all of the following advantages:

1. The fuel cell modules 312 of the fuel cells (300a, 300b, 300c, 300d, 300e, 300f, 300g, 300h) of the embodiments of the present invention includes the flow channel cover plates (310a, 310b, 310c, 310d) for transporting the anode reactant and the cathode reactant, and, therefore, no additional flow field plate is required, thereby saving the space, reducing the overall weight and material cost, of the fuel cells (300a, 300b, 300c, 300d, 300e, 300f, 300g, 300h).

2. At least the fuel cell of the second layer and the fuel cells thereunder of the fuel cells (300a, 300b, 300c, 300d, 300e, 300f, 300g, 300h) of the embodiments of the present invention include the flow channel cover plates (310a, 310b, 310c, 310d), and, therefore, the water can be effectively removed to overcome the water accumulation problem in conventional fuel cells, thereby increasing the output power of the fuel cells.

3. According to the fuel cells (300a, 300b, 300c, 300d, 300e, 300f, 300g, 300h) of the embodiments of the present invention, the fuel cells are stacked in a manner that the anode current collector faces upwards (i.e., the direction of gravity is downward), and, therefore, CO₂ produced at the anode portion can float up to the flow channel cover plate (310a, 310b, 310c, 310d) and thus will not accumulate and then block the anode reaction area, thereby the output power of the fuel cells is increased.

4. The fuel cells (300a, 300b, 300c, 300d, 300e, 300f, 300g, 300h) of the embodiments of the present invention can reduce its overall thickness and occupy small space, and, therefore, the fuel cell of the present invention is more suitable for electronic products that are light, low profile and small.

5. The embodiments of the present invention substitute the conventional flow field plate with the flow channel cover plates (310a, 310b, 310c, 310d), thus providing a larger space for airflow. As a result, the fan 316 may operate at a lower speed to drive the air to flow, which reduces addition power consumption and enhances the electricity-producing efficiency of the fuel cells. Also, lowering the fan (316) speed reduces the level of noise generated by the fan during operation.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell, comprising:
a plurality of first fuel cell modules, each of the fuel cell modules including:
a first cathode current collector;
a first anode current collector disposed above the first cathode current collector;
a first membrane electrode assembly disposed between the first anode current collector and the first cathode current collector; and
a first flow channel cover plate disposed on the first anode current collector and adapted to collect a cathode product of the fuel cell, wherein a top side of the first flow channel cover plate is adapted to transport a cathode reactant of the fuel cell, a bottom side of the first flow channel cover plate is adapted to transport an anode product of the fuel cell, and the first fuel cell modules are stacked together.

2. A fuel cell in accordance with claim 1, wherein each of the first fuel cell modules further includes a water guide layer disposed on the first flow channel cover plate.

3. A fuel cell in accordance with claim 2, wherein the water guide layer comprises a water guide micro-groove structure, a capillary structure material or a hydrophilic or hydrophobic material.

4. A fuel cell in accordance with claim 2, wherein the water guide layer comprises paper, gauze, cotton cloth or fabric material.

5. A fuel cell in accordance with claim 1, wherein the first flow channel cover plate is a serrated thin plate or a wavy thin plate.

6. A fuel cell in accordance with claim 1, wherein a top surface of the first flow channel cover plate is a planar surface, and a plurality of flow channels are formed between a bottom surface of the first flow channel cover plate and the first anode current collector corresponding to the first flow channel cover plate.

7. A fuel cell in accordance with claim 6, wherein the flow channels are adapted to be space for gas discharge, and a profile of the flow channels comprises rectangular, triangular or circular.

8. A fuel cell in accordance with claim 1, wherein a top surface of the first flow channel cover plate comprises an inclined surface, and a plurality of flow channels are formed between a bottom surface of the first flow channel cover plate and the first anode current collector corresponding to the first flow channel cover plate.

9. A fuel cell in accordance with claim 8, wherein the flow channels are adapted to be space for gas discharge, and a profile of the flow channels comprises rectangular, triangular or circular.

10. A fuel cell in accordance with claim 1, wherein a top surface of the first flow channel cover plate forms a plurality of inclined grooves, a depth of each of the inclined grooves gradually decreases along an extending direction of each of the inclined grooves, the inclined grooves extend from one side toward another side of the first flow channel cover plate corresponding to the inclined grooves, and a plurality of flow channels are formed between a bottom surface of the first flow channel cover plate and the first anode current collector corresponding to the first flow channel cover plate

11. A fuel cell in accordance with claim 10, wherein the flow channels are adapted to be space for gas discharge, and a profile of the flow channels comprises rectangular, triangular or circular.

12. A fuel cell in accordance with claim 1, wherein the first flow channel cover plate comprises an insulating material resistant to acid and alkali.

13. A fuel cell in accordance with claim 1, wherein the first fuel cell modules are interconnected by using an adhesive, a latch mechanism, a hot-pressing technique or a hot-melt technique.

14. A fuel cell in accordance with claim 1 further comprising a second fuel cell module disposed above the first fuel cell modules, and the second fuel cell module including:
a second cathode current collector;
a second anode current collector disposed above the second cathode current collector;
a second membrane electrode assembly disposed between the second anode current collector and the second cathode current collector;
a flow field plate disposed above the second anode current collector; and
a housing covering the second anode current collector and the flow field plate, wherein the second fuel cell module is arranged above the first fuel cell modules to form a stack.

15. A fuel cell in accordance with claim 14, wherein the second fuel cell module and the first fuel cell modules are interconnected by using an adhesive, a latch mechanism, a hot-pressing technique or a hot-melt technique.
